(19) United States
(12) Patent Application Publication
(10) Pub. No.: US 2026/0030724 A1
(43) Pub. Date: Jan. 29, 2026

(54) IMAGE RECONSTRUCTION WITH MULTIMODAL FUSION AND PHYSICS-INFORMED NEURAL NETWORK

(71) Applicant: University of Florida Research Foundation, Incorporated, Gainesville, FL (US)

(72) Inventors: Navid Asadi-Zanjani, Gainesville, FL (US); Nitin Varshney, Gainesville, FL (US); Shajib Ghosh, Gainesville, FL (US); Antika Roy, Gainesville, FL (US); Patrick Craig, Gainesville, FL (US); Md Mahfuz Al Hasan, Gainesville, FL (US)

(21) Appl. No.: 19/275,418

(22) Filed: Jul. 21, 2025

Related U.S. Application Data
(60) Provisional application No. 63/674,362, filed on Jul. 23, 2024.

(51) Int. Cl. G06T 5/50; G06T 5/60; G06T 11/00

(52) U.S. Cl. CPC G06T 5/50; G06T 5/60; G06T 11/006; G06T 2207/10024; G06T 2207/10116; G06T 2207/20081; G06T 2207/20084; G06T 2207/20221; G06T 2207/30148; G06T 2210/41; G06T 2211/421; G06T 2211/441; G06T 2211/452; G06T 2211/464

(57) ABSTRACT

A method comprising receiving a plurality of images from a multi-modal imaging system; generating a plurality of filtered measurements by performing multi-modal spectral fusion of the plurality of images; and generating, using a physics-informed neural network (PINN) trained based on one or more physical principles associated with X-ray attenuation or scattering, a reconstructed object image based on the plurality of filtered measurements, wherein generating the reconstructed object image comprises (i) generating, using the PINN, a system matrix for an X-ray imaging forward model by refining one or more coefficients of the system matrix based on a physics-informed loss function, and (ii) generating, using the X-ray imaging forward model and based on the plurality of filtered measurements, the reconstructed object image.

### CROSS REFERENCE TO RELATED APPLICATION

This application claims the priority of U.S. Provisional Application No. 63/674,362, entitled “IMAGE RECONSTRUCTION WITH MULTIMODAL FUSION AND PHYSICS-INFORMED NEURAL NETWORK,” filed on Jul. 23, 2024, the disclosure of which is hereby incorporated by reference in its entirety.

### BACKGROUND

The miniaturization and increasing intricacy of sophisticated semiconductor packaging pose significant challenges for non-destructive testing (NDT). With the emergence of three-dimensional integrated circuits (3D-ICs), the demand for accurate defect detection techniques has become increasingly critical.

X-ray computed tomography (CT) may be effective in unveiling internal defects and aiding in non-destructive testing across various domains. However, the scattering nature of X-ray imaging while interacting with high atomic number elements poses several limitations. Especially, in case of electronics and medical implants, which may lead to severe noisy detailing of surface level and inner-layer features because of complex miniature trends of heavy metal components and electronic devices, such as capacitors, solder bumps, solder joints etc.

Scanning acoustic microscopy (SAM) is another imaging technique that may be used to detect subsurface flaws. However, SAM images frequently suffer from high noise levels, reduced resolution, and insufficient contrast, which hinder defect detection.

### BRIEF SUMMARY

Various embodiments described herein relate to methods, apparatus, systems, computing devices, computing entities, and/or the like for enhancing scan images.

According to some embodiments, a method comprises receiving, by one or more processors, a plurality of images from a multi-modal imaging system; generating, by the one or more processors, a plurality of filtered measurements by performing multi-modal spectral fusion of the plurality of images; and generating, by the one or more processors and using a physics-informed neural network (PINN) trained based on one or more physical principles associated with X-ray attenuation or scattering, a reconstructed object image based on the plurality of filtered measurements, wherein generating the reconstructed object image comprises (i) generating, using the PINN, a system matrix for an X-ray imaging forward model by refining one or more coefficients of the system matrix based on a physics-informed loss function, and (ii) generating, using the X-ray imaging forward model and based on the plurality of filtered measurements, the reconstructed object image.

In some embodiments, the multi-modal imaging system is configured to provide the plurality of images via optical acquisition and X-ray acquisition. In some embodiments, (i) a first set of one or more images from the plurality of images comprises one or more red, green, and blue (RGB) images that are provided by the optical acquisition and (ii) a second set of one or more images from the plurality of images comprises one or more X-ray images that are provided by the X-ray acquisition. In some embodiments, performing the multi-modal spectral fusion comprises decomposing the plurality of images into one or more corresponding low-frequency components (LFCs) and one or more corresponding high-frequency components (HFCs). In some embodiments, (i) the one or more corresponding LFCs comprise one or more general shapes and (ii) the one or more corresponding HFCs comprise one or more fine details. In some embodiments, generating the plurality of filtered measurements further comprises filtering, using an attentional high-frequency feature fusion network, a first set of one or more HFCs associated with a first set of one or more images corresponding to X-ray acquisition from the plurality of images with a second set of one or more HFCs associated with a second set of one or more images corresponding to optical acquisition from the plurality of images. In some embodiments, generating the reconstructed object image further comprises supervising based on a ground truth generated by one or more model-based iterative reconstruction (MBIR) or filtered back projection algorithms. In some embodiments, the one or more coefficients of the system matrix corresponds to one or more of geometric efficiency, detector sensitivity, electronic efficiency, an attenuation term, a scatter correction factor, a beam hardening correction factor, or a detector noise factor. In some embodiments, the physics-informed loss function comprises one or more of a geometric efficiency-related adjustment or a scatter correction element.

According to some embodiments, a system comprises one or more processors and at least one memory storing processor-executable instructions that, when executed by any of the one or more processors, causes the one or more processors to perform operations comprising: receiving a plurality of images from a multi-modal imaging system; generating a plurality of filtered measurements by performing multi-modal spectral fusion of the plurality of images; and generating, using a physics-informed neural network (PINN) trained based on one or more physical principles associated with X-ray attenuation or scattering, a reconstructed object image based on the plurality of filtered measurements, wherein generating the reconstructed object image comprises (i) generating, using the PINN, a system matrix for an X-ray imaging forward model by refining one or more coefficients of the system matrix based on a physics-informed loss function, and (ii) generating, using the X-ray imaging forward model and based on the plurality of filtered measurements, the reconstructed object image.

In some embodiments, the multi-modal imaging system is configured to provide the plurality of images via optical acquisition and X-ray acquisition. In some embodiments, (i) a first set of one or more images from the plurality of images comprises one or more red, green, and blue (RGB) images that are provided by the optical acquisition and (ii) a second set of one or more images from the plurality of images comprises one or more X-ray images that are provided by the X-ray acquisition. In some embodiments, performing the multi-modal spectral fusion comprises decomposing the plurality of images into one or more corresponding low-frequency components (LFCs) and one or more corresponding high-frequency components (HFCs). In some embodiments, (i) the one or more corresponding LFCs comprise one or more general shapes and (ii) the one or more corresponding HFCs comprise one or more fine details. In some embodiments, generating the plurality of filtered measurements further comprises filtering, using an attentional high-frequency feature fusion network, a first set of one or more HFCs associated with a first set of one or more images corresponding to X-ray acquisition from the plurality of images with a second set of one or more HFCs associated with a second set of one or more images corresponding to optical acquisition from the plurality of images. In some embodiments, generating the reconstructed object image further comprises supervising based on a ground truth generated by one or more model-based iterative reconstruction (MBIR) or filtered back projection algorithms. In some embodiments, the one or more coefficients of the system matrix corresponds to one or more of geometric efficiency, detector sensitivity, electronic efficiency, an attenuation term, a scatter correction factor, a beam hardening correction factor, or a detector noise factor. In some embodiments, the physics-informed loss function comprises one or more of a geometric efficiency-related adjustment or a scatter correction element.

According to some embodiments, a method comprises receiving, by one or more processors, an input scanning acoustic microscopy (SAM) image; and generating, by the one or more processors and using a physics-informed neural network (PINN) trained based on one or more acoustic wave physics constraints, an enhanced output image of the input SAM image in accordance with a hybrid loss function, wherein the hybrid loss function comprises a physics loss function and a self-consistency loss function.

In some embodiments, the physics loss function is associated with (i) a density of an integrated circuit advanced packaging material, (ii) a wave propagation speed, and (iii) one or more second-order derivatives that corresponds to a wavefront with respect to time and spatial coordinates.

### BRIEF DESCRIPTION OF THE DRAWINGS

Embodiments incorporating teachings of the present disclosure are shown and described with respect to the figures presented herein.

FIG. 1 provides an example overview of an architecture in accordance with some embodiments of the present disclosure.

FIG. 2 provides an example computing entity in accordance with some embodiments of the present disclosure.

FIG. 3 provides an example client computing entity in accordance with some embodiments of the present disclosure.

FIG. 4A is a dataflow diagram of a multimodal fusion subsystem in accordance with some embodiments of the present disclosure.

FIG. 4B is a dataflow diagram of a multimodal fusion subsystem in accordance with some embodiments of the present disclosure.

FIG. 4C is a dataflow diagram of a multimodal fusion subsystem in accordance with some embodiments of the present disclosure.

FIG. 4D is a dataflow diagram of an example PIML model in accordance with some embodiments of the present disclosure.

FIG. 5 is a dataflow diagram of a PINN-based framework for SAM image enhancement in advanced packaging inspection in accordance with some embodiments of the present disclosure.

FIG. 6 is a dataflow diagram of an example multimodal fusion image reconstruction process in accordance with some embodiments of the present disclosure.

FIG. 7 is a dataflow diagram of an example SAM image enhancement process in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides an imaging system that combines multimodal image fusion with physics-informed machine learning (PIML), such as physics-informed neural networks (PINNs) to enable capturing of hard-to-detect features.

X-ray imaging technology, while used in a wide range of applications, such as medical diagnostics, testing, or security screening, may encounter challenges that span across varied use cases. For example, X-ray may be challenged in the differentiation and visualization of internal structures within complex objects, and may be compromised by factors such as noise, material overlap, and the physical limits of X-ray penetration. Such issues may be intensified when imaging objects that comprise diverse materials with distinct absorption coefficients, leading to the potential for significant image degradation and loss of critical detail. Furthermore, smaller, dense, and versatile materials and components within imaging samples (e.g., medical or electronics) have caused significant hurdles in inspection.

Increased complexity of modern integrated circuit (IC) packaging demands reliable non-destructive testing (NDT) techniques, especially for identifying micro-scale characteristics, such as microbumps, through-silicon vias (TSVs), and delaminations. With printed circuit boards (PCBs), 3D X-ray CT reconstruction for real-time inspection of a PCB may be significantly affected by: a) increased complexity—dense arrangement of components and layers may obscure internal structures, reducing the efficacy of traditional inspection techniques, b) noise and artifacts—modern PCB complexity may result in heightened noise and artifacts in X-ray images, complicating fault detection and analysis, and c) scattering effects—the use of high atomic number (or impedance) materials in PCB components (e.g., surface mounted devices, such as solder balls, pin grad array (PGA), capacitors etc.) may intensify scattering effects (e.g., noise-like Compton scattering), further compromising image clarity.

Traditional filtered back projection (FBP) methods may be used in CT and other imaging techniques to reconstruct images from projections. While favored for computational efficiency, traditional FBP falters under complex projections that involve densely packed PCB materials. Such a limitation stems from an inability to accommodate nuanced interactions between X-rays and high-density elements on PCBs.

Iterative reconstruction (IR) methods may be used to iteratively refine projections against actual measurements. An IR process may comprise estimating artificial raw data/projection from the input image, comparing the estimation with the real projection and compute loss, and back projecting a correction value onto a volumetric object estimate to update the initial estimation. However, while effective at reducing common noise, IR is not able to address scattering noise from materials with high atomic numbers.

Deep learning based iterative reconstruction (DLIR) methods may comprise learning a transformation from raw projection data to image space through an encoder-decoder framework. A DLIR model may be trained based on a ground-truth that is derived from high-quality projections, and once trained, may offer rapid and accurate reconstructions. However, DLIR models suffer from scattering artifacts due to traditional mean squared error (MSE) loss function as a reconstruction objective that is not explicitly correct for such effects. In addition, DLIR depends heavily on extensive ground-truth data for initial training, which is particularly challenging for X-ray images.

Scanning acoustic microscopy (SAM) may be effective for analyzing internal structures offering considerable penetration depth and material differentiation. However, SAM imaging is limited by high noise levels, reduced resolution, and insufficient contrast, which hinder accurate defect detection, particularly for micro-scale features, such as through-silicon vias (TSVs) and delaminations. Image enhancement utilizing deep learning techniques may be used improve the quality of SAM images. For example, traditional convolutional neural networks (CNNs) may exhibit a certain level of efficacy in the domains of noise reduction and enhancement of resolution; however, their functionality is inherently dependent on the availability of data and they fail to incorporate domain-specific physical principles.

Various embodiments of the present disclosure address the aforementioned obstacles by leveraging a synergy between multimodal image fusion and physics-informed neural networks (PINNs). PINNs may address such limitations by integrating physical laws into the learning paradigm such that reconstructed and/or enhanced images adhere to, for example, the dynamics of acoustic wave propagation. By incorporating physical principles into a machine learning process, features invisible to the human eye may be visualized for enhancing the quality and effectiveness of PCB inspection. In addition, some embodiments may reduce computational demands thereby fostering faster processing for larger data size tasks. The present disclosure may provide a comprehensive framework for physics-driven image enhancement in various imaging techniques, such as X-ray, SAM, optical, scanning electron microscopy (SEM), and/or infrared (IR) imaging.

In some embodiments, to overcome the challenges of traditional X-ray imaging, reconstruction methods are provided that anticipate material-specific scattering to deliver swift and accurate visualizations, thereby being suitable for semiconductor manufacturing and analysis. For example, relevant features may be extracted from X-ray imaging data to capture essential object characteristics, which may then be integrated into a machine learning model (e.g., a PINN). By including physics-based constraints, the machine learning model may align with underlying principles that govern X-ray interactions to perform inspection tasks on semiconductor structures.

Some embodiments of the present disclosure also provide a PINN-based framework for enhancing SAM images, complemented by a physics-constrained reconstruction score (PCRS) used to quantitatively evaluate the physical accuracy of enhanced SAM images. The PINN-based framework may enhance SAM images by incorporating principles of acoustic wave propagation into the loss function of a PINN to provide physically accurate image reconstructions. Unlike conventional deep learning models, PINNs may integrate physics-based constraints, thereby minimizing the potential for overfitting and improving generalization. PINN-enhanced images may comprise improved structural similarity index measure (SSIM), peak signal-to-noise ratio (PSNR), and lower PCRS.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

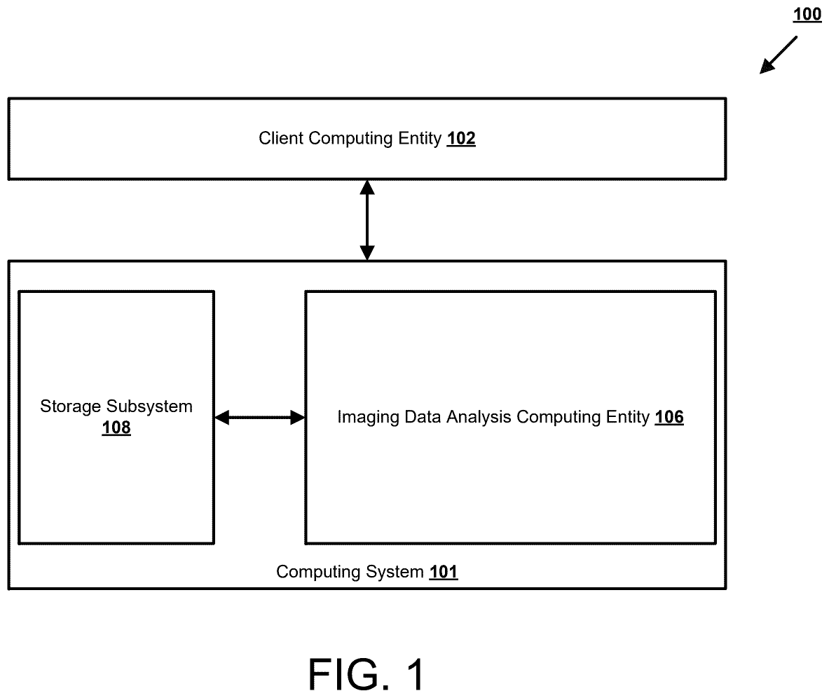

FIG. 1 provides an example overview of an architecture 100 in accordance with some embodiments of the present disclosure. The architecture 100 includes a computing system 101 configured to receive imaging data from client computing entity 102, process the imaging data to generate one or more reconstructed images (and/or enhanced images), and provide the generated one or more reconstructed images to the client computing entity 102.

In some embodiments, computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include an imaging data analysis computing entity 106 and a storage subsystem 108. The imaging data analysis computing entity 106 may be configured to receive imaging data from client computing entity 102, process the imaging data to generate one or more reconstructed images (and/or enhanced images), and provide the generated one or more reconstructed images to the client computing entity 102.

The storage subsystem 108 may be configured to store input data used by the imaging data analysis computing entity 106 to process image data. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Data Analysis Computing Entity

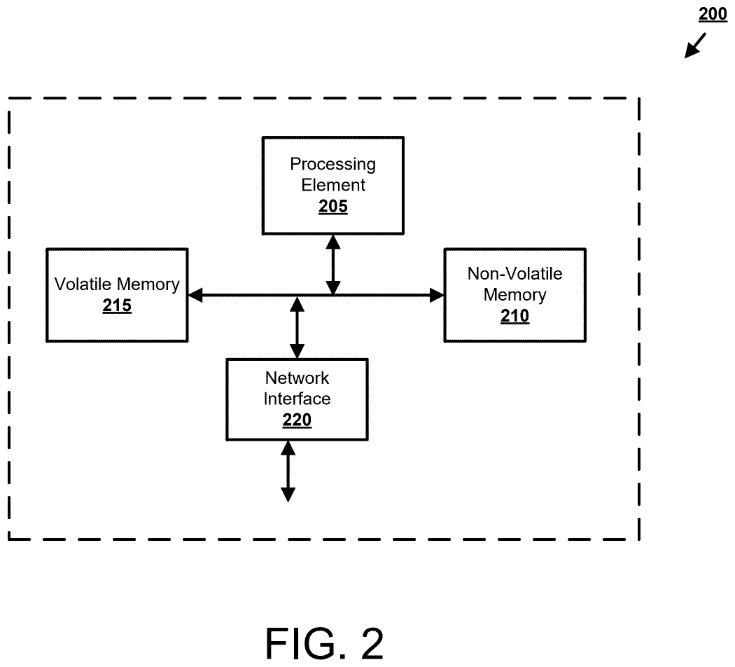

FIG. 2 provides an example computing entity 200 in accordance with some embodiments of the present disclosure. The computing entity 200 is an example of the imaging data analysis computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Client Computing Entity

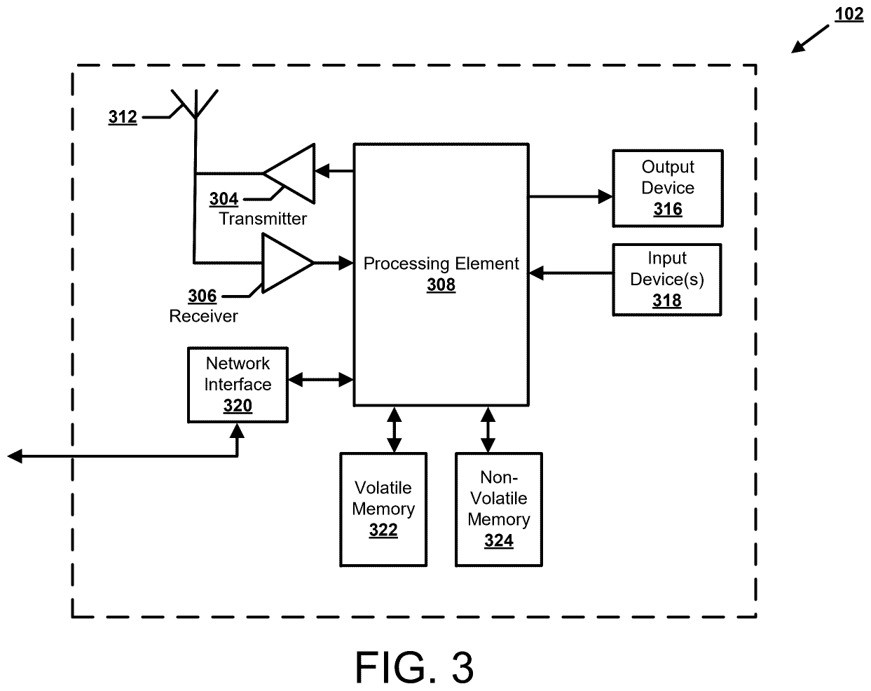

FIG. 3 provides an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionality that are the same or similar to those of the computing entity 200, as described in greater detail above. As will be recognized, these architectures and descriptions are provided for exemplary purposes only and are not limited to the various embodiments.

In various embodiments, the client computing entity 102 may be embodied as an artificial intelligence (AI) computing entity. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example PIML Architecture for Multimodal Fusion

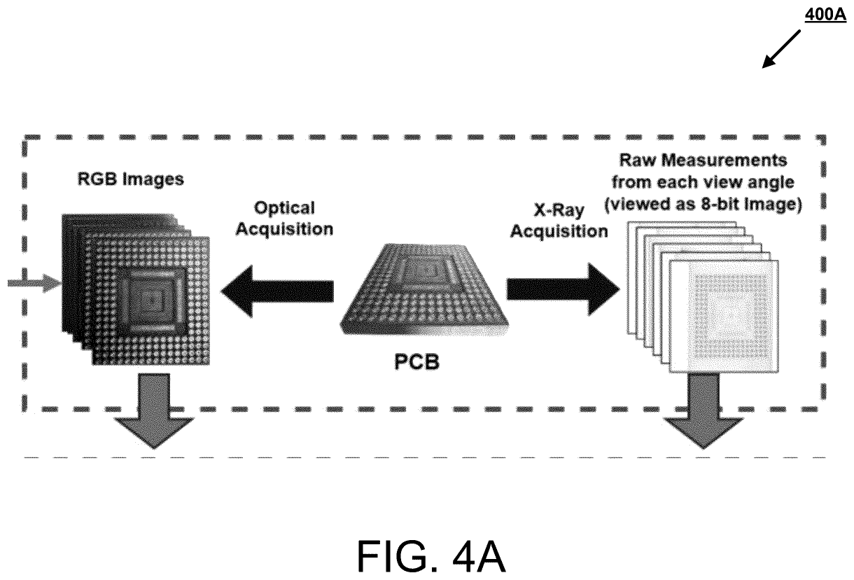

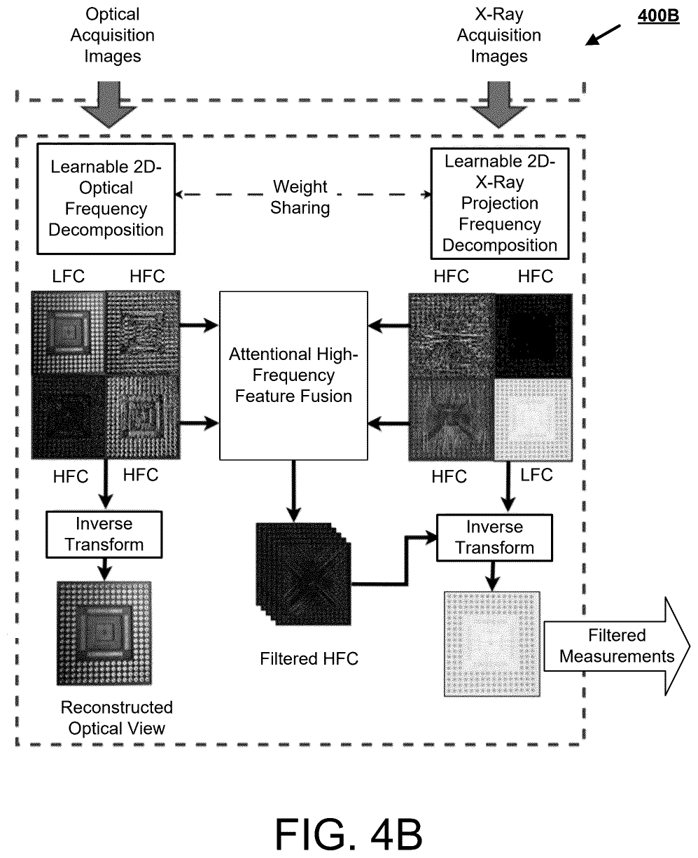

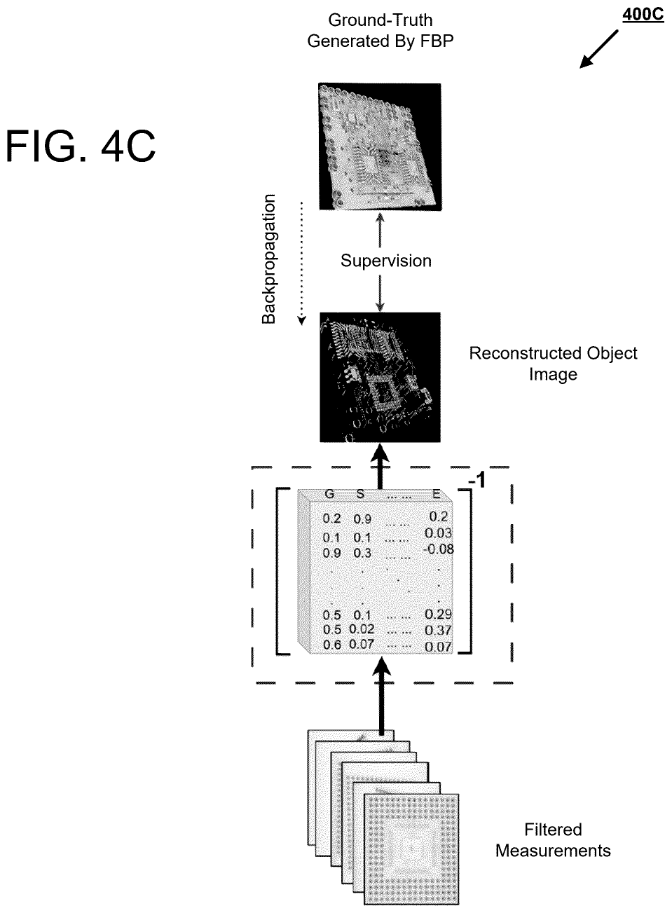

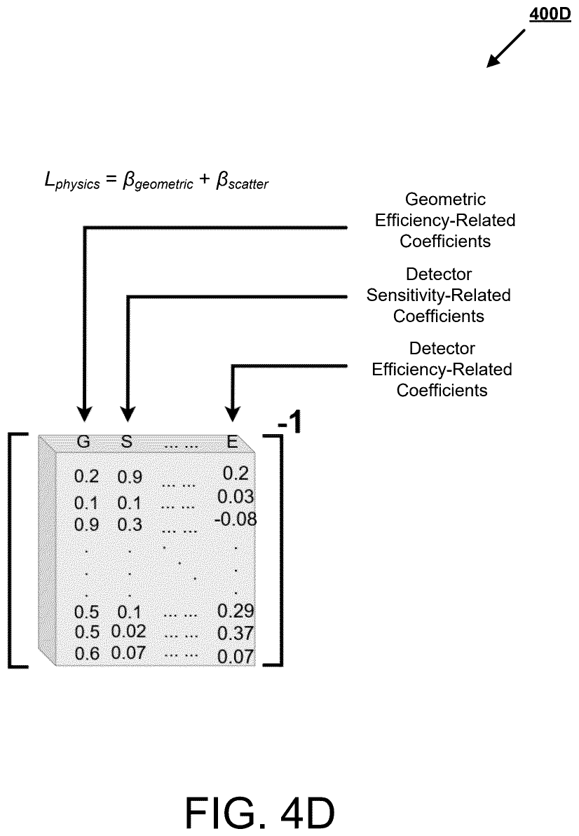

FIG. 4A is a dataflow diagram of a multimodal fusion subsystem 400A in accordance with some embodiments of the present disclosure. The multimodal fusion subsystem 400A may comprise a PCB that is configured to receive a plurality of images via optical acquisition and X-ray acquisition functionalities. For example, red, green, and blue (RGB) images may be received via optical acquisition (e.g., camera sensor) and a plurality of raw measurements (e.g., as 8-bit images) may be received via X-ray acquisition (e.g., X-ray projections from a plurality of view angles).

FIG. 4B is a dataflow diagram of a multimodal fusion subsystem 400B in accordance with some embodiments of the present disclosure. The multimodal fusion subsystem 400B may generate filtered measurements by performing multi-modal spectral fusion of optical acquisition images and X-ray acquisition images. For example, multi-modal spectral fusion comprises decomposing optical acquisition images and X-ray acquisition images into low-frequency components (LFCs) and high-frequency components (HFCs). LFCs may comprise general shapes, while HFCs may comprise fine details. In some embodiments, one or more HFCs associated with the optical acquisition images are used to filter one or more HFCs associated with the X-ray acquisition images by using an attentional high-frequency feature fusion network. By using the HFC from optical acquisition images to filter the HFC from X-ray acquisition images, final image quality may be significantly enhanced. An inverse transform may be performed on the LFCs and the HFCs from the optical acquisition images to generate a reconstructed optical image. In some embodiments, the generation of the reconstructed optical image is guided based on consistency loss to maintain coherency of generated frequency components.

FIG. 4C is a dataflow diagram of a multimodal fusion subsystem 400C in accordance with some embodiments of the present disclosure. Using a PIML model (e.g., comprising a PINN), a reconstructed object image is generated. The reconstructed object image may be generated by applying the PIML model to the plurality of filtered measurements. The generation of the reconstructed object image may be supervised based on ground truth generated by one or more model-based iterative reconstruction (MBIR)/FBP algorithms. In some embodiments, supervising the generation of the reconstructed object image comprises comprehensive end-to-end training and integration. By combining different types of images (e.g., from the plurality of images received from the multi-modal imaging system) and using a PIML model, clearer and more detailed images may be generated.

FIG. 4D is a dataflow diagram of an example PIML model 400D in accordance with some embodiments of the present disclosure. The incorporation of PIML within the matrix formulation of an imaging system (e.g., X-ray or multimodal) may improve the precision and resilience of image reconstruction by directly embedding physical constraints into an X-ray imaging forward model. PIML model 400D comprises a physics-based approximate inversion of a system matrix A, where coefficients linked to geometric efficiency G, detector sensitivity S, and detector efficiency E are initialized. These coefficients may undergo refinement via the minimization of a loss function (e.g., a physics-informed loss).

Referring back to FIG. 4C, the refined system matrix A may be employed for object model reconstruction based on the filtered measurements. The reconstruction procedure may be guided by a reference model created using methods, such as FBP. Guidance provided by the reference model may enable the PIML model 400D to undergo iterative enhancements to the system matrix A. The iterative process may be carried out for all X-ray acquisitions (projections) to maintain the consistency of the system matrix A with the principles governing X-ray interactions, thereby significantly enhancing the faithfulness of the reconstructed images.

### Example PINN-Based Architecture for SAM Image Enhancement

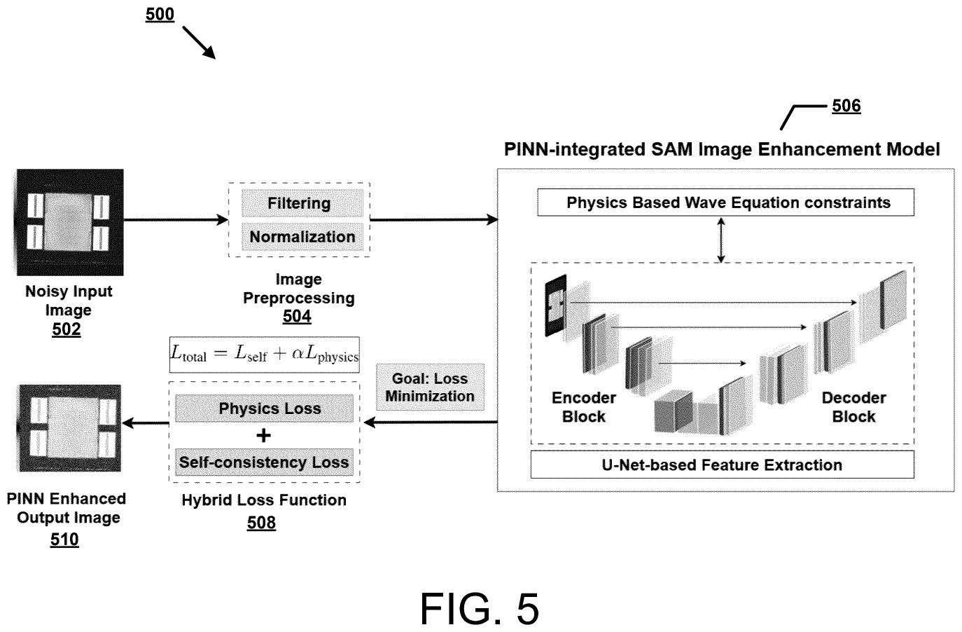

FIG. 5 is a dataflow diagram of a PINN-based framework 500 for SAM image enhancement in advanced packaging inspection in accordance with some embodiments of the present disclosure. A noisy input SAM image 502 may be provided for undergoing image preprocessing 504, such as filtering and normalization, before being fed into a PINN-integrated SAM image enhancement model 506, which integrates data-driven learning with acoustic wave physics constraints. The PINN-integrated SAM image enhancement model 506 is used to generate a PINN enhanced output image 510 by using a hybrid loss function 508 (e.g., comprising a physics loss function and a self-consistency loss function) to provide structural similarity and physics-consistency and to facilitate enhanced images with improved resolution and defect visibility. The PINN-integrated SAM image enhancement model 506 may comprise a modified U-Net architecture that enhances and/or reconstruct SAM images by directly incorporating physics-based constraints into the training methodology. For example, the PINN-integrated SAM image enhancement model 506 may comprise (i) a ResNet-50-based encoder designed for hierarchical feature extraction, (ii) a decoder comprising transposed convolutions for precise image reconstruction, and (iii) a physics-based regularization module to maintain consistency in wave propagation. In contrast to traditional CNN-based methods, the encoder may be modified to accommodate single-channel grayscale of SAM images and configured for robust generalization across various semiconductor architectures, thereby providing improved non-destructive defect detection in advanced packaging.

A significant advancement of the PINN-integrated SAM image enhancement model 506 may be provided by the incorporation of physics-based regularization. Such regularization may ensure that reconstructed images (e.g., PINN enhanced output image 510) conform to acoustic wave propagation principles governing SAM imaging via a physics-based loss function (e.g., hybrid loss function 508) that imposes constraints derived from the acoustic wave equation (Equation 5) to penalize discrepancies from anticipated material interactions. By integrating domain specific physics knowledge directly into the optimization process of the PINN architecture, the PINN-based framework 500 steers image reconstruction towards physically valid solutions, thereby improving both visual quality and scientific interpretability. A dual strategy—combining data-driven deep learning with physics-informed constraints—may enhance the fidelity of SAM images and provide robust generalization across various semiconductor architectures for non-destructive defect detection in advanced packaging.

### Example System Operations

Various embodiments of the present disclosure describe steps, operations, processes, methods, functions, and/or the like for performing enhanced object imaging.

### PIML in Computational Imaging

PIML may comprise the fusion of physical principles into machine learning frame-works to enhance interpretability and precision. In contrast to conventional data-driven methodologies that often rely on extensive datasets and may encounter challenges in generalization, PIML may integrate principles in the form of equations-such as those governing wave propagation, heat diffusion, or X-ray attenuation-directly into the structure of a machine learning model. Such integration may result in machine learning models that are physically accurate and resilient, particularly in scenarios with limited data availability. For instance, in the domain of X-ray imaging, the incorporation of the Beer-Lambert law into a machine learning model may enable adherence to established physical laws, resulting in more dependable image enhancements/reconstructions and improved handling of noisy data. As such, PIML may obviate the reliance on large training datasets and enhance a machine learning model's capacity to extrapolate beyond observed data, a feature especially beneficial in fields, such as medical imaging, non-destructive testing, and/or remote sensing applications.

In addition to being particularly useful for X-ray imaging, various embodiments of the present disclosure may be applied to many different types of imaging technologies and used in a wide range of fields (e.g., medical imaging, electronics inspection, and security screening). For example, the disclosed systems and methods may be used in medical imaging to help doctors see inside the body more clearly, leading to better diagnoses and treatments. In another example, the disclosed systems and methods may be used in electronics inspection to improve the inspection of complex devices, to provide higher quality and reliability.

### X-Ray Image Enhancement/Reconstruction

X-ray computed tomography (CT) scans may be used in various fields, such as medical diagnostics, electronics, and security, to inspect the inside of objects without damaging them. However, X-ray CT technology faces significant challenges, especially when dealing with complex materials, such as metals found in electronics and/or medical implants. Such challenges may include noise, material overlap, and the physical limits of X-ray penetration, which may obscure important details.

X-ray imaging may operate based on the principles of X-ray attenuation and scattering in accordance with the Beer-Lambert law. The Beer-Lambert law describes an exponential reduction in X-ray intensity as they traverse a substance, where attenuation is dependent upon density and thickness of a material, characterized by its linear attenuation coefficient. Moreover, scattering phenomena, such as Compton and Rayleigh scattering, may contribute to shaping the propagation of X-rays, adding to the intricacy of the image formation process. Such physical principles may be important for precise establishment of a system matrix in X-ray imaging, such that algorithms for image reconstruction faithfully depict interactions between X-rays and substances under examination.

According to various embodiments of the present disclosure, a PINN is used to generate a system matrix in an X-ray imaging forward model. As such, physical principles, such as X-ray attenuation and scattering according to the Beer-Lambert law, may be directly incorporated (e.g., trained) within a machine learning framework. Through the creation of a neural network that minimizes a combined loss function, balancing data fidelity with compliance to physical laws, precise and understandable system matrices may be generated, even with limited training data. Accordingly, improved predictive capabilities and resilience may be provided by a PINN in X-ray imaging applications.

An X-ray imaging forward model may comprise a system matrix, a measurement vector, and an object's attenuation coefficients. A system matrix A may represent an X-ray attenuation process that links an object's internal structure to measurements detected by a sensor. A measurement vector y may be obtained by projecting X-rays through the object and capturing attenuated beams, expressed as y=Ax+n, where x may represent the object's attenuation coefficients and n may denote noise. The attenuation of X-rays obeys the Beer-Lambert law, which may mathematically explain an exponential reduction in X-ray intensity based on material thickness and an attenuation coefficient μ. The system matrix A may correspond to such physical interactions, incorporating the X-ray system's geometry and the object's material properties.

A generation of an initial system matrix and an integration of PIML may be influenced by a plurality of factors that affect precision and dependability in X-ray imaging forward models.

Material Properties: The assumptions of homogeneity and isotropy concerning the material properties of an object may significantly impact the accuracy of a system matrix. Variations in density and composition may demand the adaptability of the system matrix to reflect these heterogeneities, thus averting reconstruction errors.

Geometric Configuration: The relative positions of an X-ray source, object, and detector may exert influence on a geometric efficiency term. Precise modeling of such positions may be important such that a system matrix may accurately depict X-ray paths through an object.

Energy Spectrum and Detector Response: The energy spectrum of an X-ray source and a response function of a detector may directly impact attenuation and detector sensitivity terms, underscoring the significance of their accurate representation for realistic imaging.

Scattering Effects: Materials with high density may introduce substantial scattering, potentially distorting measured signals. The inclusion of scatter correction factors within a system matrix may alleviate scattering and uphold the fidelity of image reconstruction.

Noise Modeling: Environmental noise and/or electronic noise within a detector system may influence the assumptions of an initial system matrix. Robust noise modeling and correction mechanisms are imperative for ensuring that the integration of PIML adeptly manages uncertainties due to noise, thereby preserving the accuracy of reconstructed images.

### System Matrix Generation for X-Ray Imaging Forward Models

A system matrix A in an X-ray imaging forward model may represent a relationship between attenuation properties of an object and detected X-ray measurements. As such, the system matrix A may play an important role in translating the internal structure of an object into measurable projection data at a detector (e.g., imaging device). A measurement at the i-th detector element, denoted as bi, may be given by:

$${b}_{i} = {\sum }_{j = 1}^{N} {A}_{ij} {x}_{j} \qquad Equation 1$$

where (i) bi may comprise measured projection data at the i-th detector element, representing the total X-ray signal detected after passing through an object, (ii) Aᵢⱼ may comprise the i, j-th element of the system matrix, quantifying the contribution of the j-th voxel to the i-th detector element, (iii) xⱼ may comprise the attenuation coefficient of voxel j, indicating how much the X-ray is attenuated as it passes through the voxel j, and (iv) N may comprise a total number of discretized voxels in the object, each contributing to an overall projection measured by the detector.

Assumptions may be incorporated into an initial (e.g., traditional) system matrix representation for X-ray imaging forward models that correspond to assumptions of homogeneity and isotropy of material properties within individual voxels, together with the assumption of linearity in X-ray interactions with objects. Gaussian priors may be employed to initialize a system matrix due to their capacity to offer mathematical tractability and effectively capture anticipated smooth variations in attenuation coefficients throughout objects. As such, a Gaussian distribution's capability to portray uncertainty and establish a statistically sound framework may be important for incorporating physical constraints and noise characteristics into an X-ray imaging forward model. Such a methodology may provide an initial system matrix that is both practical and computationally effective, thereby laying strong groundwork for further enhancement through iterative techniques via PINNs.

According to various embodiments of the present disclosure, an updated formulation of a system matrix element Aij may incorporate factors that influence the detection process and may be mathematically expressed as:

$${A}_{ij} = {G}_{j} \cdot {S}_{j} \cdot {E}_{j} \cdot {e}^{- {μ}_{j} {l}_{ij}} \cdot ( 1 + {σ}_{j} ) \cdot {H}_{j} \cdot {N}_{j} \qquad Equation 2$$

where:

Geometric efficiency Gⱼ may represent the fraction of X-ray photons that successfully reach a detector after interacting with an object. Geometric efficiency may account for the geometrical configuration of an X-ray source, an object, and a detector. Thus, geometric efficiency may ensure that a system matrix reflects the physical reality of how X-rays traverse through objects, considering factors, such as divergence of an X-ray beam and a distance from a source to a detector.

Detector sensitivity Sⱼ may represent a detector's capability to convert incident X-ray photons into measurable electrical signals. Detector sensitivity may account for a detector's intrinsic properties, such as material composition and design, which influence the detector's responsiveness to incoming X-ray flux. Thus, high detector sensitivity may provide accurate measurements as it maximizes the conversion of X-ray energy into a detectable signal.

Electronic efficiency Eⱼ may represent an effectiveness of a detector's electronic components in converting analog signals, generated by incident X-rays, into digital data. Electronic efficiency may comprise the efficiency of analog-to-digital conversion processes, signal amplification, and/or noise reduction mechanisms within a detector's electronics. Higher electronic efficiency may ensure that detected signals are accurately digitized with minimal loss of information.

Attenuation Term e^{-μ}jlij may comprise an exponential term that represents the attenuation of X-ray intensity as it passes through a j-th voxel of an object. According to the Beer-Lambert law, X-ray intensity may decrease exponentially with the product of an attenuation coefficient μj and a path length lᵢⱼ through a voxel. The attenuation term may be important to a system matrix as it directly relates material properties of an object to X-ray measurements, ensuring that denser or thicker materials contribute more to attenuation.

Scatter correction factor σⱼ may comprise a variable that accounts for a contribution of scattered radiation from a j-th voxel to measured data. Scattered X-rays, which deviate from their original path after interacting with an object, may introduce errors in measurement. The scatter correction factor σⱼ may adjust for such errors, improving the accuracy of a system matrix by mitigating the impact of scatter on a detected signal.

Beam hardening correction factor Hⱼ may comprise a variable that compensates for beam hardening, which may occur when X-rays of different energies are attenuated at different rates, leading to a shift in the effective energy spectrum of an X-ray beam as it passes through an object. The beam hardening correction factor Hⱼ may ensure that the attenuation term accurately reflects energy-dependent attenuation characteristics of a material. Beam hardening correction may be particularly important for imaging materials with high atomic numbers, where beam hardening effects are more pronounced.

Detector noise factor Nⱼ may represent an impact of noise on measured data and may comprise various sources of uncertainty, such as electronic noise in a detector, quantum noise from an X-ray source, and/or environmental noise. The detector noise factor Nⱼ may contribute to an overall uncertainty in reconstructed images and may be important for accurately representing the stochastic nature of a measurement process.

Incorporating the aforementioned factors into a system matrix A may allow for a more accurate and realistic representation of ab X-ray imaging process, capturing the complex interplay between an X-ray source, an object, and a detector. This comprehensive formulation is critical for improving the accuracy of image reconstruction, particularly in applications where high precision is required.

In some embodiments, the incorporation of PIML in a system matrix for an X-ray imaging system may improve the precision and resilience of image reconstruction by directly embedding physical constraints into an X-ray imaging forward model. For example, generating a system matrix may comprise performing a physics-based approximate inversion of a system matrix A, where coefficients linked to geometric efficiency G, detector sensitivity S, and detector efficiency E may be initially included. These coefficients may undergo refinement via the minimization of a loss function L_{physics}, which may be defined as:

$${L}_{physics} = {β}_{geometric} + {β}_{scatter} \qquad Equation 3$$

with β_{geometric} addressing geometric efficiency-related adjustments and β_{scatter} accommodating a scatter correction element.

### Image Enhancement/Reconstruction Via Multimodal Fusion and PINN

Various embodiments of the present disclosure address the aforementioned challenges of X-ray imaging by combining information from different types of images and using neural networks guided by physics principles (e.g., PIML and/or PINNs). In some embodiments, information from different types of images is combined (herein referred to as “multimodal fusion”) such that details from various sources, such as X-ray images and photographs (optical images) may be merged to create a single enhanced image. That is, features from optical images may be mapped to 3D X-ray images to visualize details that are invisible to the human eye. By taking details from flat, color images and using them to enhance 3D X-ray images, image enhancement and analysis may be improved. For example, by integrating detailed color information from an optical image with structural information from an X-ray image, images may be generated that are significantly clearer and richer in detail than those generated by either type of image alone.

In some embodiments, details from multimodal fusion are reconstructed into an enhanced image based on a PINN. Traditional neural networks may learn to improve image quality by recognizing patterns in data. PINNs may further improve image quality by incorporating rules from physics into the machine learning process. For example, known physical principles may be used to guide model parameter adjustments, which may help correct mistakes and enhance the accuracy of images. For instance, PINNs can better account for how X-rays interact with different materials, leading to more precise reconstructions of objects. Moreover, by combining multimodal image fusion with PINNs, high-quality image reconstruction may be achieved without relying on vast amounts of training data.

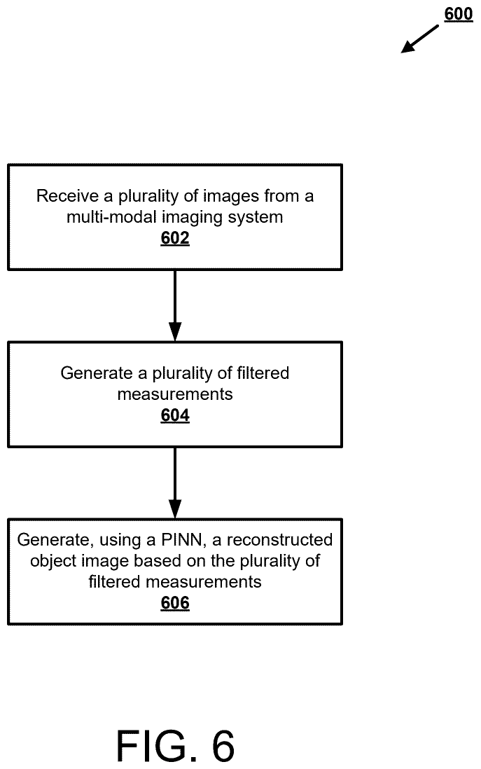

FIG. 6 is a dataflow diagram of an example multimodal fusion image reconstruction process 600 in accordance with some embodiments of the present disclosure.

In some embodiments, the multimodal fusion image reconstruction process 600 begins at step 602, when the computing system 101 receives a plurality of images from a multi-modal imaging system. The multi-modal imaging system may comprise a PCB that is configured to provide optical acquisition and X-ray acquisition functionalities. For example, a plurality of RGB images may be received via optical acquisition (e.g., camera sensor) and a plurality of raw measurements (e.g., as 8-bit images) may be received via X-ray acquisition (e.g., X-ray projections from a plurality of view angles).

In some embodiments, at step 604, the computing system 101 generates a plurality of filtered measurements. The plurality of filtered measurements may be generated by performing multi-modal spectral fusion of the plurality of images. For example, multi-modal spectral fusion comprises decomposing the plurality of RGB images and X-ray projections into low-frequency components (LFC) and high-frequency components (HFC). LFC may comprise general shapes, while HFC may comprise fine details. In some embodiments, HFC from the RGB images are used to filter HFC from the X-ray projections by using a deep spectral fusion (DSF) manner that comprises an attentional high-frequency feature fusion network. By using the high-frequency details from optical images to filter the high-frequency details from X-ray images, a final image quality may be significantly enhanced.

In some embodiments, at step 606, the computing system 101 using a PINN, generates a reconstructed object image (or enhanced output image). The reconstructed object image may be generated by applying the PINN to the plurality of filtered measurements. The generation of the reconstructed object image may be supervised based on ground truth generated by one or more MBIR/FBP algorithms. In some embodiments, supervising the generation of the reconstructed object image comprises comprehensive end-to-end training and integration. In some embodiments, generating the reconstructed object image may further comprise (i) generating, using the PINN, a system matrix for an X-ray imaging forward model by refining coefficients of the system matrix based on a physics-informed loss function, and (ii) generating, using the X-ray imaging forward model and based on the plurality of filtered measurements, the reconstructed object image.

By combining different types of images (e.g., from the plurality of images received from the multi-modal imaging system) and using a PINN, clearer and more detailed images may be generated. Various embodiments of the present disclosure may also reduce the need for extensive training datasets thereby providing enhanced imaging that is more cost-effective and accessible. At least some of the disclosed embodiments may be used in various applications from medical imaging to electronics and may introduce innovative mapping techniques that enhance 3D X-ray images with details from optical images. Accordingly, the present disclosure provides significant advancements in the field of image reconstruction and discloses a powerful tool to overcome the limitations of current X-ray technology.

Advanced Semiconductor Packaging Inspection using SAM

Achieving high-resolution acoustic imaging for three-dimensional heterogeneous integration (3DHI) devices may be challenging due to the interplay of various physical and technological factors, such as transducer frequency, aperture size, sound velocity, focal length, and time-of-flight (TOF) consistency during scanning. Higher-frequency transducers may improve lateral resolution but at the cost of higher signal-to-noise ratio (SNR), resulting in increased noise and reduced image clarity. As such, the aforementioned challenges may inhibit the accuracy and/or precision of defect detection, as distinguishing actual defects from imaging artifacts becomes difficult. Additionally, TOF variations across different depths in 3DHI structures may introduce phase distortions and reflection losses at multiple material interfaces, that may demand continuous TOF compensation strategies. Even with surface triggers designed to maintain focus, certain regions may suffer from defocus-related artifacts, further complicating the accuracy of defect identification.

The limitations of C-Scan imaging resolution may pose another significant hurdle in achieving high-resolution acoustic imaging, particularly when analyzing densely packed structures at high frequencies. As stacked dies continue to miniaturize, thinner layers and shorter ultrasound delay times between interfaces may cause signal overlap, thereby reducing the precision of failure analysis. Furthermore, material-dependent acoustic impedance mismatches may present additional complexities, as modern semiconductor packaging integrates diverse materials, such as silicon, molding compounds, underfill, and redistribution layers, may exhibit distinct acoustic properties. Such variations may lead to reflection and scattering effects, making it difficult to achieve uniform image contrast and reliable defect characterization across different layers. Moreover, the penetration depth limitation of high-frequency transducers may restrict the ability of SAM to detect deeply embedded defects, such as internal voids or delamination in multi-layered wafer-level packaging.

According to various embodiments of the present disclosure, PINNs may provide a transformative approach for enhancing SAM images by integrating properties of wave physics directly into the learning framework. Traditional deep learning methods for SAM image enhancement may depend exclusively on data-driven optimization, neglecting physical principles that govern the interactions of ultrasonic waves. Consequently, image reconstructions may seem visually convincing yet lack physical accuracy. In contrast to conventional deep learning techniques that depend exclusively on data-driven feature extraction, PINNs may maintain physical consistency by incorporating domain-specific constraints, such as wave propagation dynamics and relationships of acoustic impedance, within a neural network design. Such an approach may enable reconstructions that provide high perceptual fidelity and comply with physical principles governing ultrasound imaging. The inclusion of physics-aware regularization may also alleviate challenges, such as overfitting and the generation of artificial features, such that enhanced images accurately reflect true material structures.

A physics-constrained metric may also be implemented and incorporate domain-specific physics—particularly principles of acoustic wave propagation—into the image enhancement process. For example, PCRS may be used as an evaluation standard that measures how well reconstructed images align with the established physical laws that dictate ultrasonic wave interactions in semiconductor materials. By integrating physics-based constraints, PCRS may offer a more comprehensive evaluation of image quality such that enhancements retain material-specific acoustic properties and defect characteristics.

### Physics of Acoustic Wave Propagation in Semiconductor Packaging

Acoustic Impedance and Reflection Properties: Ultrasonic wave interactions with semiconductor materials may be influenced by discrepancies in acoustic impedance. The acoustic impedance of a given material may be characterized as:

$$Z = ρ c \qquad Equation 4$$

where ρ may represent the material density and c may denote acoustic velocity. At material interfaces, a portion of wave energy may be reflected while the remainder of the wave energy is transmitted, with reflection and transmission coefficients given by:

$$R = {( \frac{{Z}_{2} - {Z}_{1}}{{Z}_{2} - {Z}_{1}} )}^{2} , T = 1 - R \qquad Equation 5$$

where Z₁ and Z₂ may represent the acoustic impedances of the respective layers.

In semiconductor packaging, differences in impedance across materials, such as silicon, metal interconnects, and polymer-based underfills, may significantly affect SAM imaging by changing the intensity and contrast of reflected signals. The disclosed PCRS metric may integrate impedance-weighted factors such that the reconstructed images accurately depict anticipated reflection intensities and defect contrasts according to properties of the materials.

Attenuation and Scattering Effects: Ultrasonic waves propagating through semiconductor structures may experience attenuation due to absorption and scattering, which may result in a reduction of wave intensity. Attenuation may follow the exponential decay model,

$$I ( x ) = {I}_{0} {e}^{- ax} \qquad Equation 6$$

where I(x) may represent the intensity after propagation distance x, Iₒ may denote an initial intensity, and a may represent an attenuation coefficient.

Attenuation may be significantly prominent in polymeric materials, leading to a diminished visibility of defects in deeper layers. The disclosed PCRS metric may amalgamate attenuation correction models to rectify such anomalies in a manner where image reconstructions may preserve anticipated signal intensity decay. Moreover, scattering phenomena, particularly at grain boundaries of polycrystalline interconnects, may engender phase distortions that impair resolution. Through the integration of frequency-dependent correction models, PCRS may be used to augment image fidelity and mitigate the risk of artificial enhancement of subsurface characteristics.

Wave Dispersion and Mode Conversion: A phenomenon of ultrasonic wave dispersion and mode conversion may be observed in anisotropic materials and multi-layered semiconductor architectures, wherein acoustic waves undergo transitions between longitudinal and shear wave modes. The phase velocity of a wave in a dispersive medium may be given by,

$${v}_{p} = \frac{ω}{K} \qquad Equation 7$$

where ω may represent angular frequency and κ may denote a wave number.

Mode conversion effects may create phase distortions that disrupt precise defect localization. The disclosed PCRS metric may incorporate dispersion compensation models that rectify frequency-dependent phase velocity fluctuations, such that improved SAM images maintain accurate phase relationships of ultrasonic waves.

Physics-Guided Time-of-Flight (TOF) Compensation for Depth Accuracy: Defect localization in SAM imaging may be based on time-of-flight (TOF) measurements, which assess the depths of subsurface features according to wave transit times. Nonetheless, TOF calculations may be prone to inaccuracies because of variations in material velocity and multi-path reflections. To address such challenges, the disclosed PCRS metric may penalize TOF inconsistencies by enforcing solutions to the following acoustic wave equation:

$${∇}^{2} u - \frac{1}{{v}^{2}} \frac{{\partial }^{2} u}{\partial {t}^{2}} = 0 \qquad Equation 8$$

where u may denote the acoustic displacement field, t may denote time, and v may denote local wave velocity.

Through the incorporation of physics-informed TOF correction models, the disclosed PINN-based framework may provide precise depth localization while reducing inaccuracies stemming from multi-path propagation effects.

### SAM Image Enhancement

Physics-Informed Neural Networks (PINNs) for SAM: In some embodiments, PINNs incorporate constraints derived from partial differential equations (PDEs) into the training of neural networks. For example, rather than exclusively depending on data-driven loss functions, PINNs may assimilate physical laws that characterize the dynamics of a system-specifically, wave propagation within the domain of imaging physics. In contrast to traditional deep learning approaches that are limited by small datasets, PINNs embed universal physical principles, rendering them versatile in adapting to unique IC designs and varying imaging conditions. In some embodiments, PINNs are based on and/or trained to minimize a physics-based loss function that imposes penalties on outputs that contravene pre-defined physical laws, thereby averting the emergence of artifacts that may be generated in purely data-driven methodologies.

Loss Functions: The learning objective of the disclosed PINN models may be formulated as a combined loss function (e.g., hybrid loss function 508) that balances both data-driven learning and physical constraints such that enhanced images exhibit high perceptual fidelity and remain consistent with underlying physics of acoustic wave propagation. A combined loss function Lₜₒₜₐₗ may be expressed as:

$${L}_{total} = {L}_{self} + {aL}_{physics} \qquad Equation 9$$

where (i) L_{self} may comprise a self-consistency loss that is used to ensure that an enhanced image closely approximates an original noisy image, (ii) L_{physics} may comprise a physics-informed loss that enforces physical consistency by incorporating wave propagation constraints, and (iii) a may comprise a tunable hyperparameter that controls the weight of L_{physics} in the overall optimization of Lₜₒₜₐₗ.

A self-consistency loss may comprise a MSE for evaluating reconstruction accuracy in image denoising tasks. The self-consistency loss may penalize deviations between an enhanced image, I_{enhanced}, and an input noisy image, I_{noisy}, such that a PINN model may preserve underlying and/or important structures/features while removing noise. Self-consistency loss may be defined as:

$${L}_{self} = MSE ( {I}_{enhanced} , {I}_{noisy} ) \qquad Equation 10$$

$$where ,$$

$$MSE ( {I}_{enhanced} , {I}_{noisy} ) = \frac{1}{N} {\sum }_{i = 1}^{N} {( {I}_{enhanced}^{i} - {I}_{noisy}^{i} )}^{2} \qquad Equation 11$$

and N may represent a number of pixels in the input and/or enhanced image. Accordingly, a self-consistency loss function may ensure that an enhanced/reconstructed image remains structurally faithful to an original input image while reducing noise artifacts.

To incorporate domain expertise into the learning process, a physics-informed loss function may be formulated based on the acoustic wave equation (Equation 5) to dictate ultrasound imaging in semiconductor materials. Such a physics-informed loss function may correspond to an adherence to core principles of acoustic wave interaction, such that reconstructed and/or enhanced images preserve authentic structural and material characteristics. Using a finite difference approximation, a physics-informed loss may be defined as:

$${L}_{physics} = {‖ ρ \cdot {u}_{tt} - {c}^{2} \cdot ( {u}_{xx} + {u}_{yy} ) ‖}^{2} \qquad Equation 12$$

where ρ may represent a density of an IC advanced packaging material, c may represent wave propagation speed, and uₜₜ, uₓₓ, u_{yy} may comprise second-order derivatives with respect to time, t, and spatial coordinates (x, y), capturing the evolution of a wavefront over time and space.

By implementing compliance with the principles of acoustic wave propagation, the physics-informed loss may prevent a PINN from generating physically implausible artifacts commonly observed in entirely data-driven models. The integration of a physics-informed loss may enable a PINN to generalize more proficiently across diverse semiconductor packaging materials and configurations, while simultaneously ensuring that image reconstructions and/or enhancements are physically interpretable.

Accordingly, the synergy between self-consistency loss and physics loss may establish a resilient PINN-based framework for denoising SAM images, improving both perceptual quality and physical reliability, such that enhanced images generated by using the PINN-based framework preserve structural accuracy and improve defect visibility in semiconductor packaging inspection.

Evaluation Metrics: To evaluate the quality of enhanced and/or reconstructed SAM images, one or more evaluation metrics may be used. For example, a structural similarity index (SSIM) may be used to gauge structural fidelity, a peak signal-to-noise ratio (PSNR) may be used to measure noise reduction efficacy, and a physics-constrained reconstruction score (PCRS) may be used to determine physical coherence in the process of image reconstruction/enhancement.

SSIM may evaluate the perceptual resemblance between an enhanced/reconstructed image and an original input image by taking into account luminance, contrast, and/or structural integrity. In contrast to pixel-wise error metrics, SSIM may correlate more closely with human visual perception, rendering it an effective tool for quality assessment. SSIM may be defined as:

$$SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} \qquad Equation 13$$

where μₓ and μ_{y} may represent the mean pixel values of images x and y, respectively, σₓ² and σ_{y}² may represent variances of the images x and y, σ_{xy} may denote the covariance between the images x and y, and C₁ and C₂ may represent small stabilizing constants to prevent division by zero. An SSIM value close to ‘1’ may indicate a high degree of structural preservation.

PSNR may comprise a metric for assessing the efficacy of noise reduction techniques by calculating a proportion of a highest signal power relative to noise artifacts that are present in an enhanced/reconstructed image. PSNR may be expressed in decibels (dB) and computed as:

$$PSNR = 10 {log}_{10} ( \frac{{MAX}^{2}}{MSE} ) \qquad Equation 14$$

where MAX may denote a maximum possible pixel value, and MSE may represent a MSE between original and enhanced/reconstructed images. A higher PSNR value may indicate superior noise suppression, with values above 40 dB may correspond to high-quality image restoration.

PCRS may comprise a metric aimed at assessing how well a reconstructed/enhanced image aligns with principles of wave propagation. In contrast to SSIM and PSNR, which focus on evaluating perceptual image quality, PCRS may ensure that reconstructed/enhanced images remain physically coherent with the dynamics of acoustic waves. PCRS may be defined as:

$$PCRS = {‖ ρ \cdot {u}_{tt} - {c}^{2} \cdot ( {u}_{xx} + {u}_{yy} ) ‖}^{2} \qquad Equation 15$$

where ρ may represent material density, c may represent wave propagation speed, and uₜₜ, uₓₓ, u_{yy} may denote second-order derivatives with respect to time, t, and spatial coordinates (x, y), modeling the temporal and spatial evolution of an acoustic wavefront. A lower PCRS value may indicate that an enhanced/reconstructed image closely follows expected physical properties of wave interactions, ensuring scientifically valid and interpretable reconstructions.

Although the physics-informed loss and the PCRS share a same mathematical formulation, the physics-informed loss may comprise an optimization constraint that is applied during training to enforce physical consistency, whereas PCRS may comprise a post-training evaluation metric that assesses how well enhanced/reconstructed images adhere to physical laws without influencing a model's (e.g., PINN) learning process.

Adaptive Loss Balancing: A dynamic adjustment mechanism for the weight of the physics-informed loss (e.g., a) may prevent excessive over-smoothing while ensuring strong adherence to physical principles. For example, implementing a learning rate scheduler for loss weighting may facilitate a PINN to adaptively fine-tune an equilibrium between self-consistency (e.g., corresponding to self-consistency loss) and physics constraints (e.g., corresponding to physics-informed loss) throughout various phases of training, optimizing both structural integrity and noise mitigation. Such an adaptive loss balancing may be advantageous in intricating advanced packaging structures, where precise detection of fine-scale defects, such as voids, delaminations, and micro-cracks is desired without introducing artifacts.

Hybrid Physics-Perceptual Training: An integration of a perceptual loss function along with physics constraints (e.g., physics-informed loss) may enhance SSIM scores by preserving intricate textures and contrast details without sacrificing the effectiveness of noise removal. A hybrid methodology that merges physics-informed constraints with feature-level supervision may empower a PINN to maintain both high-level structural coherence and low-level textural integrity, thereby generating more perceptually accurate image enhancements/reconstructions. This may be particularly advantageous in heterogeneous semiconductor packages, where various material interfaces, such as silicon, polymers, and interconnect metals, may demand meticulous handling to prevent information loss during defect localization.

Real-Time Optimization: To reduce computational overhead, alternative strategies, such as approximate second-order derivative calculations may be employed to expedite physics-informed training. Furthermore, lighter-weight architectures optimized for real-time deployment in industrial semiconductor failure analysis and quality control may enhance the disclosed PINN-based framework's scalability for high-throughput defect inspection. Efficient execution of PINN-based models may facilitate quicker inline metrology in semiconductor fabrication plants, promoting early defect detection in three-dimensional integrated circuits, advanced interposers, and/or chiplet-based designs without sacrificing inspection accuracy.

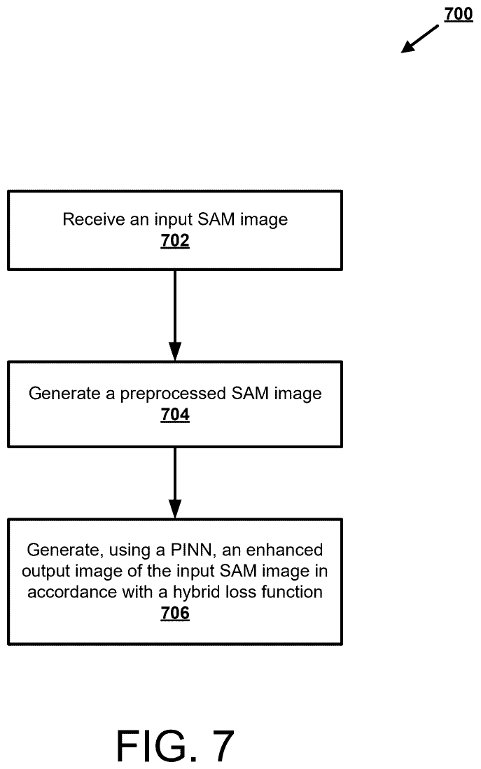

FIG. 7 is a dataflow diagram of an example SAM image enhancement process 700 in accordance with some embodiments of the present disclosure.

In some embodiments, the SAM image enhancement process 700 begins at step 702, when the computing system 101 receives an input SAM image. The input SAM image may comprise a noisy SAM image that is provided to the computing system 101 for reconstruction and/or enhancement with improved resolution and defect visibility.

In some embodiments, at step 704, the computing system 101 generates a preprocessed SAM image. The input SAM image may undergo image preprocessing, such as filtering and normalization, before being further processed.

In some embodiments, at step 706, the computing system 101 generates, using a PINN, an enhanced output image of the input SAM image in accordance with a hybrid loss function. The preprocessed SAM image may be provided to the PINN and used to generate the enhanced output image. The PINN may comprise a PINN-integrated SAM image enhancement model that integrates data-driven learning (e.g., trained) with acoustic wave physics constraints, as disclosed herewith. The hybrid loss function may comprise a physics loss function and a self-consistency loss function to provide structural similarity and physics-consistency and to facilitate enhanced images with improved resolution and defect visibility.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method comprising:
receiving, by one or more processors, a plurality of images from a multi-modal imaging system;
generating, by the one or more processors, a plurality of filtered measurements by performing multi-modal spectral fusion of the plurality of images; and
generating, by the one or more processors and using a physics-informed neural network (PINN) trained based on one or more physical principles associated with X-ray attenuation or scattering, a reconstructed object image based on the plurality of filtered measurements, wherein generating the reconstructed object image comprises (i) generating, using the PINN, a system matrix for an X-ray imaging forward model by refining one or more coefficients of the system matrix based on a physics-informed loss function, and (ii) generating, using the X-ray imaging forward model and based on the plurality of filtered measurements, the reconstructed object image.

2. The computer-implemented method of claim 1, wherein the multi-modal imaging system is configured to provide the plurality of images via optical acquisition and X-ray acquisition.

3. The computer-implemented method of claim 2, wherein (i) a first set of one or more images from the plurality of images comprises one or more red, green, and blue (RGB) images that are provided by the optical acquisition and (ii) a second set of one or more images from the plurality of images comprises one or more X-ray images that are provided by the X-ray acquisition.

4. The computer-implemented method of claim 1, wherein performing the multi-modal spectral fusion comprises decomposing the plurality of images into one or more corresponding low-frequency components (LFCs) and one or more corresponding high-frequency components (HFCs).

5. The computer-implemented method of claim 4, wherein (i) the one or more corresponding LFCs comprise one or more general shapes and (ii) the one or more corresponding HFCs comprise one or more fine details.

6. The computer-implemented method of claim 4, wherein generating the plurality of filtered measurements further comprises filtering, using an attentional high-frequency feature fusion network, a first set of one or more HFCs associated with a first set of one or more images corresponding to X-ray acquisition from the plurality of images with a second set of one or more HFCs associated with a second set of one or more images corresponding to optical acquisition from the plurality of images.

7. The computer-implemented method of claim 1, wherein generating the reconstructed object image further comprises supervising based on a ground truth generated by one or more model-based iterative reconstruction (MBIR) or filtered back projection algorithms.

8. The computer-implemented method of claim 1, wherein the one or more coefficients of the system matrix corresponds to one or more of geometric efficiency, detector sensitivity, electronic efficiency, an attenuation term, a scatter correction factor, a beam hardening correction factor, or a detector noise factor.

9. The computer-implemented method of claim 1, wherein the physics-informed loss function comprises one or more of a geometric efficiency-related adjustment or a scatter correction element.

10. A system comprising
one or more processors and
at least one memory storing processor-executable instructions that, when executed by any of the one or more processors, causes the one or more processors to perform operations comprising:
receiving a plurality of images from a multi-modal imaging system;
generating a plurality of filtered measurements by performing multi-modal spectral fusion of the plurality of images; and
generating, using a physics-informed neural network (PINN) trained based on one or more physical principles associated with X-ray attenuation or scattering, a reconstructed object image based on the plurality of filtered measurements, wherein generating the reconstructed object image comprises (i) generating, using the PINN, a system matrix for an X-ray imaging forward model by refining one or more coefficients of the system matrix based on a physics-informed loss function, and (ii) generating, using the X-ray imaging forward model and based on the plurality of filtered measurements, the reconstructed object image.

11. The system of claim 10, wherein the multi-modal imaging system is configured to provide the plurality of images via optical acquisition and X-ray acquisition.

12. The system of claim 11, wherein (i) a first set of one or more images from the plurality of images comprises one or more red, green, and blue (RGB) images that are provided by the optical acquisition and (ii) a second set of one or more images from the plurality of images comprises one or more X-ray images that are provided by the X-ray acquisition.

13. The system of claim 10, wherein performing the multi-modal spectral fusion comprises decomposing the plurality of images into one or more corresponding low-frequency components (LFCs) and one or more corresponding high-frequency components (HFCs).

14. The system of claim 13, wherein (i) the one or more corresponding LFCs comprise one or more general shapes and (ii) the one or more corresponding HFCs comprise one or more fine details.

15. The system of claim 13, wherein generating the plurality of filtered measurements further comprises filtering, using an attentional high-frequency feature fusion network, a first set of one or more HFCs associated with a first set of one or more images corresponding to X-ray acquisition from the plurality of images with a second set of one or more HFCs associated with a second set of one or more images corresponding to optical acquisition from the plurality of images.

16. The system of claim 10, wherein generating the reconstructed object image further comprises supervising based on a ground truth generated by one or more model-based iterative reconstruction (MBIR) or filtered back projection algorithms.

17. The system of claim 10, wherein the one or more coefficients of the system matrix corresponds to one or more of geometric efficiency, detector sensitivity, electronic efficiency, an attenuation term, a scatter correction factor, a beam hardening correction factor, or a detector noise factor.

18. The system of claim 10, wherein the physics-informed loss function comprises one or more of a geometric efficiency-related adjustment or a scatter correction element.

19. A computer-implemented method comprising:
receiving, by one or more processors, an input scanning acoustic microscopy (SAM) image; and
generating, by the one or more processors and using a physics-informed neural network (PINN) trained based on one or more acoustic wave physics constraints, an enhanced output image of the input SAM image in accordance with a hybrid loss function, wherein the hybrid loss function comprises a physics loss function and a self-consistency loss function.

20. The computer-implemented method of claim 19, wherein the physics loss function is associated with (i) a density of an integrated circuit advanced packaging material, (ii) a wave propagation speed, and (iii) one or more second-order derivatives that corresponds to a wavefront with respect to time and spatial coordinates.
